(19) United States
(12) Patent Application Publication
(10) Pub. No.: US 2025/0032986 A1
(43) Pub. Date: Jan. 30, 2025

(54) CONCENTRATOR SYSTEM, KIT FOR ASSEMBLING THE SAME, AND CORRESPONDING METHODS OF ASSEMBLING, OPERATING AND USE ASSOCIATED THERETO

(71) Applicant: LES ÉQUIPEMENTS LAPIERRE INC., St-Ludger (CA)

(72) Inventor: Carl LAPIERRE, St-Ludger (CA)

(21) Appl. No.: 18/786,229

(22) Filed: Jul. 26, 2024

Related U.S. Application Data
(60) Provisional application No. 63/515,992, filed on Jul. 27, 2023.

(51) Int. Cl. B01D 61/02; B01D 1/26; C13B 20/16

(52) U.S. Cl. CPC B01D 61/025; B01D 1/26; C13B 20/165; B01D 2313/243

(57) ABSTRACT

A concentrator system is for processing maple sap for production of maple syrup. The concentrator system includes a fluid circuit for receiving maple sap to be processed from a given source of maple sap. At least one osmotic membrane is operatively disposed about the fluid circuit and in fluid connection with the maple sap to be processed, for passing the maple sap to be processed through the at least one osmotic membrane, at differential pressure of at least 600 PSI, in order to withdraw water content from the maple sap being processed and thus obtain a resulting concentrated maple sap in one single step.

### CROSS-REFERENCE TO RELATED APPLICATION

The present application claims the benefit of U.S. Provisional Application No. 63/515,992, filed Jul. 27, 2023, the disclosure of which is incorporated herein by reference in their entirety.

### FIELD OF THE INVENTION

The present invention relates to the field of the production of syrup, such as maple syrup, for example, and/or any other type of syrup. More particularly, the present invention relates to a concentrator system, being typically used for increasing the concentration in sugar of a given sugary liquid, such as maple sap, for example, and also relates to a kit with corresponding components for assembling the same, and to corresponding methods of manufacturing, operating and/or use associated thereto.

### BACKGROUND

The process of transforming maple sap into maple syrup requires the increase in sugar content of the maple sap, primarily by water evaporation and cooking the sugar. Maple syrup evaporators are used for this purpose. Typically, the energy source of maple syrup evaporators is either biomass or hydrocarbons. Biomass can take the form of firewood or wood residue transformed into woodchips or wood pallets, for example.

It is also known that increasing the sugar concentration of maple sap via evaporation requires a lot of energy (thus, lots of biomass or hydrocarbons, etc.), which is very undesirable, for obvious reasons (ex. in terms of costs of operating and materials being required, as well as for environmental reasons, etc.).

In some cases, it is possible to a obtain concentrated maple sap having an increased level of ° Brix, prior to using an evaporator and associated energy being required to operate the same, but one typically has to resort to more complicated reverse osmosis machines being disposed in “cascading” configurations, which require many, elaborate and incremental steps, as well as many, elaborate and different associated equipment and components, etc.

For example, some of these more sophisticated reverse osmosis machines are commercialized by the very same Applicant/Assignee as that of the present case, including the machines known as:
a) the “2000 Series” (https://elapierre.com/en/2000-series/);
b) the “3000 Series” (https://elapierre.com/en/3000-series/);
c) the “5000 Series” (https://elapierre.com/en/5000-series/); and
d) the “10000 Series” (https://elapierre.com/en/10000-series/).

Also known in the art are the patented technologies having been developed over the years by the very same Applicant/Assignee as that of the present case.

For example, U.S. Pat. No. 4,702,842, granted on Oct. 27, 1987 (as well as CA U.S. Pat. No. 1,274,781, granted on Oct. 2, 1990), in the name of LAPIERRE, relates to an “apparatus for reverse osmosis using fluid recirculation”. This document describes a membrane element pumping and circulation mechanism comprising a pressure vessel containing a centrifugal pumping mechanism and a membrane module wherein aqueous fluid to be purified undergoes active circulation and purification while following a continuous path without leaving the primary container; as well as a purification process using the mechanism.

U.S. Pat. No. 5,082,561, granted on Jan. 21, 1992 (as well as CA U.S. Pat. No. 2,025,578, granted on Sep. 1, 1998), in the name of LAPIERRE, relates to “high pressure filter supports for liquids, systems therewith and methods of use”. This document describes a high pressure filter support for liquids having low or high viscosity. The support is easily cleanable and quickly dismountable. The support comprises an annular passage defined between an outer larger tubular wall and an inner smaller tubular wall, top and bottom flat plates including quick release fastening means for sealingly joining the top plate to the outer and inner tubular walls to obtain the annular passage sealingly closed. Inlet means into said annular passage are provided. The inner wall inside the annular passage has on its surface a plurality of circumferential grooves. Each of the grooves has at least one orifice through the inner wall. The orifices are of a size commensurate with the viscosity of the material to be displaced through the orifices. An outlet means is sealingly mounted on the surface of the inner wall away from the annular passage to receive the orifices. A system for making maple syrup comprising an evaporator, a filter as defined above is also disclosed. A process for the filtration of maple syrup is also disclosed. It comprises evaporating sap to obtain a syrup, feeding under pressure the syrup, by passing under pressure the syrup between a pair of concentric tubular walls as defined above, the syrup passing from said concentric tubular walls to a filter along said grooves to said orifices, and collecting from said orifices said syrup so filtered.

U.S. Pat. No. 11,441,199 B2, granted on Sep. 13, 2022, in the name of LAPIERRE et al., relates to a “controller of the release of energy of a combustion of biomass, system provided with such a controller, kit for assembling the same, and corresponding methods of assembling, operating and use associated thereto”. This document describes an evaporator system used for the production of maple syrup. The evaporator system comprises at least one receptacle for receiving and processing maple water destined to be transformed, a combustion chamber for burning biomass, and a detector of temperature of the combustion. The evaporator system also comprises an air supply system being operatively mounted with respect to the combustion chamber for feeding the same with air destined to be used in the combustion of the biomass, the air supply system offering at least one type of air supply to the combustion chamber selected from the group consisting of a primary air supply, a secondary air supply and an intermediate air supply, the air supply system including at least one corresponding fan for generating said at least one type of air supply to the combustion chamber, and said at least one fan being configured for transmitting an air flow being automatically variable according to the operating temperature in the combustion chamber, so as to control the release of energy from the combustion of the biomass in the combustion chamber, thus in order to enable a more constant release of energy in the combustion chamber during the production of maple syrup.

U.S. Pat. No. 11,624,097 B2, granted on Apr. 21, 2023, in the name of GRANGER et al., relates to an “evaporator system, kit for assembling the same, and corresponding methods of assembling, operating and use associated thereto”. This document describes an evaporator system used for the production of maple syrup. The evaporator system includes at least one receptacle, a combustion chamber, an evacuation port and an air supply system. The evaporator system also includes a door assembly being configured for removably mounting onto a corresponding support frame of the evaporator system, and being operable between an opened configuration for allowing access to the combustion chamber and to be able to selectively feed biomass into the combustion chamber via the inlet thereof, and a closed configuration for preventing access to and closing off the inlet of the combustion chamber, the door assembly being provided with at least one aeration passage extending between an outer portion of the door assembly and an inner portion therefor, for providing a supply of secondary air to the combustion chamber via said at least one aeration passage of the door assembly when operated in the closed configuration.

Despite known improvements over the years, there is always a need to continue innovating and finding better and/or different ways of concentrating maple sap and/or various aspects thereof (ex. reducing biomass being required to do, etc.), for example, and to be able do so, in a quicker, simpler, more precise, more efficient, more economical, more reliable, more adjustable, more versatile, more adaptable, more durable, more environmentally conscientious, more desirable, and/or improved manner, than what is possible with the actual way of doing things.

Therefore, it would be particularly useful to be able to provide an improved concentrator system (and/or associated method) which would be able to overcome or at the very least minimize some of known drawbacks associated with conventional systems and ways of doing in the field of maple syrup production, for example.

### SUMMARY OF THE INVENTION

An object of the present invention is therefore to provide a concentrator system which by virtue of its design and its components, would satisfy some of the above-mentioned needs, and which would thus be an improvement over other related concentrators, systems and/or methods known in the prior art.

The above main object is achieved, as will be better understood, by a concentrator system (and/or associated method) such as the one briefly described in the present description, and such as the one exemplified in the accompanying drawings.

More particularly, and according to one aspect of the present invention, an objective is to provide a concentrator system for processing maple sap intended for a production of maple syrup, the concentrator system comprising:
a fluid circuit for receiving maple sap to be processed from a given source of maple sap; and at least one osmotic membrane operatively disposed about the fluid circuit and in fluid
connection with the maple sap to be processed, for passing said maple sap to be processed through the at least one osmotic membrane, at differential pressure of at least 600 PSI, in order to withdraw water content from the maple sap being processed and thus obtain a resulting concentrated maple sap in one single step.

According to another aspect of the present invention, there is also provided a water-extraction assembly comprising at least one component (ex. osmotic membrane) and/or feature, as described and/or illustrated in the present specification, and intended to be used with the above-mentioned concentrator system.

According to another aspect of the present invention, there is also provided a kit with corresponding components for assembling the above-mentioned water-extraction assembly and/or concentrator system.

According to another aspect of the present invention, there is also provided a method of assembling components of the above-mentioned water-extraction assembly and/or concentrator system.

According to another aspect of the present invention, there is also provided a method of operating the above-mentioned water-extraction assembly and/or concentrator system.

According to another aspect of the present invention, there is also provided a method of using the above-mentioned water-extraction assembly and/or concentrator system.

According to another aspect of the present invention, there is also provided a set of components to be interchanged on the above-mentioned water-extraction assembly and/or concentrator system.

According to another aspect of the present invention, there is also provided a method of manufacturing one and/or another of the components of the above-mentioned water-extraction assembly and/or concentrator system.

According to another aspect of the present invention, there is also provided a method of operating one and/or another of the components of the above-mentioned water-extraction assembly and/or concentrator system.

According to another aspect of the present invention, there is also provided a method of concentrating maple sap using one and/or another of the components of the above-mentioned water-extraction assembly and/or concentrator system.

According to another aspect of the present invention, there is also provided a product (ex. syrup, whether maple syrup and/or any other type of syrup) having been obtained with the above-mentioned water-extraction assembly, concentrator system, kit, component(s) and/or method(s).

According to another aspect of the present invention, there is also provided a method of doing business with the above-mentioned water-extraction assembly, concentrator system, kit, component(s), method(s), component(s), set and/or product.

The objects, advantages, and other features of the present invention will become more apparent upon reading of the following non-restrictive description of preferred embodiment(s) thereof, with reference to the accompanying drawings, and given for the purpose of exemplification only.

### BRIEF DESCRIPTION OF THE DRAWINGS

FIG. 1 is a schematic representation of a concentrator system according to a possible embodiment of the present invention.

FIG. 2 is a schematic perspective representation of a corresponding osmotic membrane located inside a corresponding substantially rigid container, and being shown provided with at least one inlet and a pair of outlets, as well as a corresponding recirculating device, according to a possible embodiment of the present concentrator system.

FIG. 3 is a schematic elevational representation of a corresponding osmotic membrane located inside a corresponding substantially rigid container, and being shown provided with at least one corresponding recirculation device, according to a possible embodiment of the present concentrator system.

FIG. 4 is a schematic cross-sectional representation of a corresponding osmotic membrane located inside a corresponding substantially rigid container, and being shown provided with at least one inlet for receiving the maple sap to be processed, according to a possible embodiment of the present concentrator system.

### DETAILED DESCRIPTION

In the following description, the same numerical references refer to similar elements. Furthermore, for sake of simplicity and clarity, namely so as to not unduly burden the figures with several reference numbers, only some figures have been provided with reference numbers, and components and features of the present invention illustrated in other figures can be easily inferred therefrom. The embodiments, geometrical configurations, materials mentioned and/or dimensions shown in the figures are preferred, for exemplification purposes only.

Moreover, although the present invention was primarily designed for a “concentrator” system (or simply, a “concentrator”) intended to extract “water” from a corresponding “maple sap” (for example), such as to obtain a resulting concentrated maple sap, with increased level(s) of ° Brix (i.e. higher concentrated levels of “sugar” content per volume, etc.), intended to be used for syrup production purposes, such as that of maple syrup, for example, the invention may be used with any other type of system and/or for any other type of application and/or useful end, as apparent to a person skilled in the art. For this reason, expressions such as “concentrator”, “extract”, “water”, “maple sap”, “syrup”, “sugar”, “° Brix”, etc., as used herein, and/or any other reference(s) and/or expression(s) equivalent or similar to these expressions should not be taken so as to limit the scope of the present invention and include any other kind of object/substitute and/or any other application with which the present invention could be used and may be useful, as apparent to a person skilled in the art.

Moreover, in the context of the present invention, expressions such as “concentrator”, “system”, “kit”, “device”, “assembly”, “mechanism”, “product”, “apparatus”, “add-on”, “retrofit”, “water-extraction”, “osmotic membrane”, “reverse osmosis”, etc., as well as any other equivalent expression(s) and/or compound word(s) thereof, may be used interchangeably in the context of the present description, as apparent to a person skilled in the art. This applies also for any other mutually equivalent expressions, such as: a) “extract”, “withdraw”, “remove”, “reduce”, “take-away”, “seep out”, etc.; b) “water”, “fluid”, “liquid”, “solution”, “undesirable”, etc.; c) “drive”, “channel”, “conduit”, “draw”, “pump”, “push”, “pull”, “flow”, “bias”, “differential pressure”, “pressurize”, etc.; d) “concentrate”, “densify”, “increase”, etc.; e) “comprise”, “include”, “provide”, “contain”, “dispose”, etc.; f) “controller”, “command”, “computer”, “circuit”, “hardware”, “software”, “program”, “electric, electronic and computer components”; as well as any other mutually equivalent expressions, related to the aforementioned expressions and/or to any other structural and/or functional aspects of the present invention, as also apparent to a person skilled in the art.

Furthermore, in the context of the present description, it will be considered that all elongated objects will have an implicit “longitudinal axis” or “centerline”, such as the longitudinal axis of an elongated object (ex. pipe, channel, cylinder, coiled membrane, etc.), for example, or the centerline of a coiled spring, for example, and that expressions such as “connected” and “connectable”, or “mounted” and “mountable”, may be interchangeable, in that the present invention also relates to a kit with corresponding components for assembling a resulting fully-assembled and fully-operational concentrator system.

Moreover, components of the present system(s) and/or steps of the method(s) described herein could be modified, simplified, altered, omitted and/or interchanged, without departing from the scope of the present invention, depending on the particular application(s) which the present invention is intended for, and the desired end result(s), as briefly exemplified herein and as also apparent to a person skilled in the art.

In addition, although the preferred embodiments of the present invention as illustrated in the accompanying drawings comprise various components, and although the preferred embodiments of the present concentrator system and corresponding portion(s)/part(s)/component(s) (ex. water-extraction assembly, osmotic membrane, etc.) as shown consist of certain geometrical configurations, as explained and illustrated herein, not all of these components and geometries are essential to the invention and thus should not be taken in their restrictive sense, i.e. should not be taken so as to limit the scope of the present invention. It is to be understood, as also apparent to a person skilled in the art, that other suitable components and cooperation there in between, as well as other suitable geometrical configurations may be used for the present concentrator system and corresponding portion(s)/part(s)/component(s) according to the present invention, as will be briefly explained herein and as can be easily inferred here from by a person skilled in the art, without departing from the scope of the present invention.

Broadly described, the present invention, as illustrated in the accompanying figures, relates to an improved concentrator system (and/or associated method) which, among various other advantages, enables to process maple sap intended for a production of maple syrup, where the maple sap to be processed is passed through at least one osmotic membrane subject to a differential pressure of at least 600 PSI, in order to obtain a resulting concentrated maple sap having an increase level of ° Brix (ex. more than 25° Brix, for example), in one single step, without having to resort to long and/or complicated “cascading” configurations, which require many complicated steps and associated equipment and components, as is the case with conventional systems and ways of doing, etc. The present invention also relates to a kit with corresponding components intended for assembling the same (ex. water-extraction assembly and/or concentrator system), and/or to put into practice the resulting water-extraction assembly and/or concentrator system, as well as to corresponding methods of assembling, operating, concentrating and/or use associated thereto.

Furthermore, it is worth mentioning that the present invention/technology can not only be commercialized as a “resulting concentrator system”, per se, but also, via the commercialization and sales of associated component(s) and/or parts thereof only, as well, such as, for example, a water-extraction assembly, an associated osmotic membrane, etc.

Preliminary Information, Including Reminder and/or Overview of the “Brix” Scale/Measurement

As is known in the art, and as explained in Wikipedia™, for example:
“Degrees Brix (symbol ° Bx) is a measure of the dissolved solids in a liquid, and is commonly used to measure dissolved sugar content of an aqueous solution.[1] One degree Brix is 1 gram of sucrose in 100 grams of solution and represents the strength of the solution as percentage by mass. If the solution contains dissolved solids other than pure sucrose, then the ° Bx only approximates the dissolved solid content. For example, when one adds equal amounts of salt and sugar to equal amounts of water, the degrees of refraction (BRIX) of the salt solution rises faster than the sugar solution. The ° Bx is traditionally used in the wine, sugar, carbonated beverage, fruit juice, fresh produce, maple syrup and honey industries. The ° Bx is also used for measuring the concentration of a cutting fluid mixed in water for metalworking processes.
Comparable scales for indicating sucrose content are: the Plato scale (° P), which is widely used by the brewing industry; the Oechsle scale used in German and Swiss wine making industries, amongst others; and the Balling scale, which is the oldest of the three systems and therefore mostly found in older textbooks, but is still in use in some parts of the world.[2]
A sucrose solution with an apparent specific gravity (20°/20° C.) of 1.040 would be 9.99325° Bx or 9.99359° P while the representative sugar body, the International Commission for Uniform Methods of Sugar Analysis (ICUMSA), which favours the use of mass fraction, would report the solution strength as 9.99249%. Because the differences between the systems are of little practical significance (the differences are less than the precision of most common instruments) and wide historical use of the Brix unit, modern instruments calculate mass fraction using ICUMSA official formulas but report the result as ° Bx.”.
   Some Additional Preliminary Information about the Present System

The maple syrup industry uses inverse osmosis technology in order to increase the sugar concentration of maple sap being harvested before carried out the transformation of the maple sap into maple syrup.

The maple sap being harvested presents on average a sugar concentration of about 2° Brix. A maple syrup typically presents a sugar concentration of about 66° Brix. In order to pass from a sugar concentration of 2° Brix to 66° Brix (approx.), it is necessary to eliminate from the solution 42 volumes of water per volume of maple syrup being produced. The elimination of water via evaporation is the historical manner of producing maple syrup, because given that it is necessary to carry out a cooking of the sugar, the evaporation combines both operations being required: an increase of the concentration in sugar via an evaporation of water, as well as a cooking (ex. caramelization, etc.) of the sugar.

As previously mentioned, the increase of the concentration in sugar via evaporation requires a lot of energy. Also, conventional “cascading” concentrators that rely on reverse osmosis may be used, given that they require less energy to increase the concentration in sugar. In practice, one typically uses the notion of “percentage of increase in concentration” to define the capacity of a reverse osmosis equipment (or concentrator). The “percentage of increase” is usually defined (and/or calculated) as follows:

(1,0−° Brix at the inlet/° Brix at the outlet)×100

For example: (1,0−2° Brix/10° Brix)×100=80% increase in concentration.

Common practice is to increase the concentration to about 92% (to attain a concentration of about 25° Brix, and in “Hyperbrix™” (trademark expression used, contemplated and/or owned by the Applicant/Assignee of the present case) of about 93-94% (up to about 35° Brix).

The capacity of a reverse osmosis membrane to increase a given concentration depends on the osmotic pressure, that is, on the differential pressure between the two sides of the membrane. The performances of a membrane are thus generally limited by the maximal osmotic pressure that the membrane can sustain, as well as by the rate of clogging of the membrane by the solids contained in the solution to be treated, etc.

These limitations have led to a conventional way of thinking and doing, namely, relying on “cascading” configuration(s) of many concentrators put together in series, with thus, many associated pressurizing pumps, one for each cascading step and increment. As a result, the greater the desired increase in percentage of sugar concentration, the greater the number of incremental steps and associated cascading configuration, resulting in an overall machine that is quite complicated and takes up a lot of space, and that relies on many, elaborate and incremental steps, as well as many, elaborate and different associated equipment and components, etc.

As will be better understood when going through the present patent specification and accompanying drawings, the present concentrator is particularly advantageous in that, due to its innovative design and working principle, it enables the carrying out of an increase of sugar concentration of about 92%, in one single step, while taking up very little space, with a volumetric capacity that is ideally suited for smaller sugar shacks and/or smaller producers of maple syrup, for example.

### General Overview of the “Components” and “Features” of the Present Concentrator System

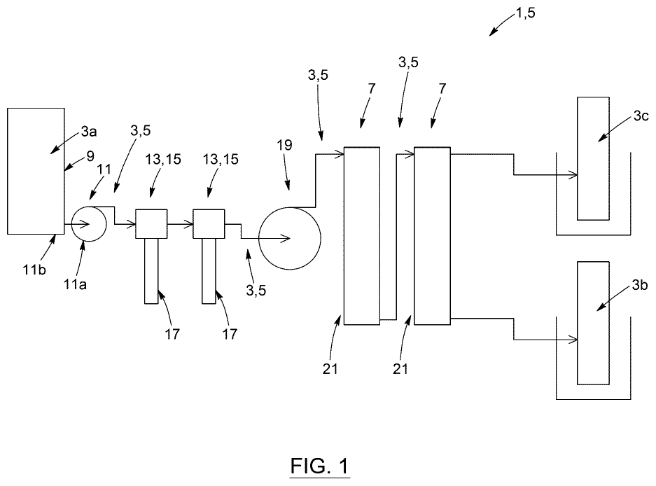

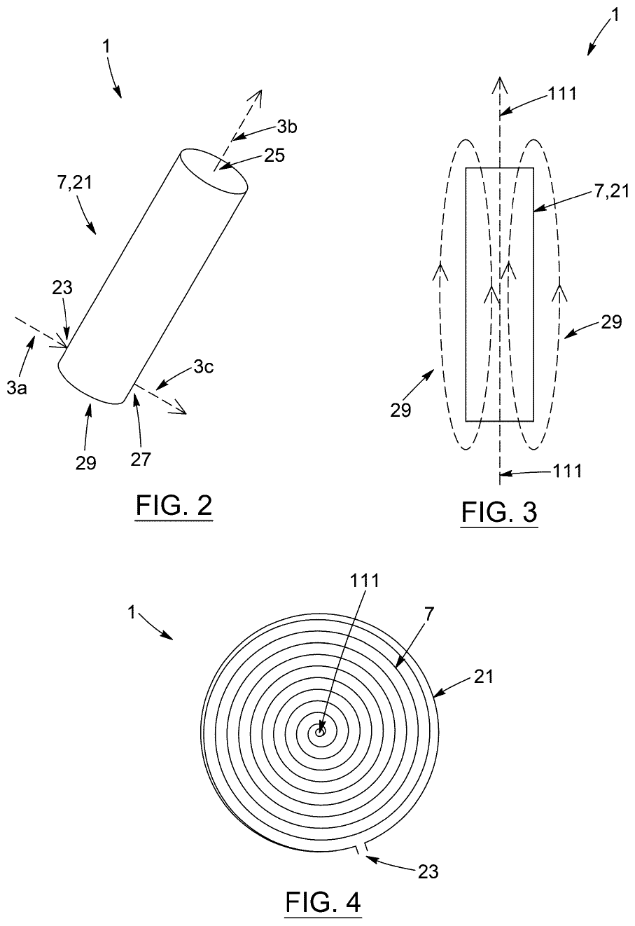

When referring to FIG. 1, for instance, and according to given possible embodiment of the present system, one can easily understand that the hydraulic/fluid circuit may include (for example):
a) at least one feeding pump for the concentrator;
b) at least one filtering unit (which may come in the form of a “cartridge filter”, for example);
c) at least one and/or several high-pressure osmotic pump(s), which may or may not be disposed in parallel, to produce a pressure differential of at least 600™ pounds-per-square inch″ (psi), in one single step; and
d) at least one and/or several high-pressure osmotic membrane(s), which may or may not be disposed in series (for example, in the case of a plurality of high-pressure osmotic membranes being used, etc.).

### General Overview of the “Functionalities” of the Present Concentrator System

One can also easily understand from FIG. 1 that, according to given possible embodiment, for instance, the present concentrator system may operate as follows (for example):
a) the solution to be concentrated is transferred from the collection reservoir via the feeding pump;
b) the capacity of the feeding pump is determined by the debit of the solution to be processed and by the loss of pressure during the passage in the filtering unit(s) (ex. “cartridge filter(s)”);
c) at least one high-pressure osmotic pump (or several such pumps connected in parallel), pressurize(s) in one single step the solution to be process at a differential pressure of at least 600 pounds-per-square inch (psi);
d) the osmotic membrane unit increases the concentration of the solution at a percentage of concentration greater than 92% (approximately);
e) the concentrated solution is evacuated into a reservoir configured for feeding a corresponding maple syrup evaporator;
f) the filtered water (i.e. water content having been extracted) is either rejected or evacuated into a reservoir that may be used as a source of sanitary water;
g) by using one single step to produce an osmotic high-pressure and one single osmotic membrane unit, the resulting concentrator is much simpler (ex. to construct, to operate, to maintain, etc.);
h) by using one single membrane unit, the resulting concentrator also takes up much less space than other conventional “cascading” concentrators; and
i) given that clogging of a given osmotic membrane is a function of the volume of the solution being processed, the limited debit of the concentrator presents a rate of clogging that is similar and/or better than industry standards.

### General Overview of the “Advantages” of the Present Concentrator System

As can be easily understood when referring to the present specification and accompanying drawing(s), the present system is particularly advantageous in that:
a) concentration of the original/raw maple sap (±2° Brix) is done in one single step, so as to concentrate the maple sap to at least 25° Brix (which is very desirable, prior to feeding into an evaporator);
b) the system only requires and uses a single pressurization step having a pressure differential of more than 600 psi (for increased simplicity and efficiency, as well as increased quality of processed maple sap, etc.);
c) the system offers a high percentage (%) of concentration (ex. 25° Brix and more), with very little volume being required, which is particularly desirable for smaller sugar shacks and/or smaller producers of maple syrup;
d) the system, due to its innovative design, takes up much less space than conventional “cascading” systems, and this is achieved namely via the use of a single high-pressure step, as well as a single osmotic membrane unit; and
e) the system, due to its innovative design, offers a high percentage (%) of concentration thanks via the use of a high-pressure pump and a corresponding high-pressure osmotic membrane.

The reading of the following paragraphs, in association with the drawings, will enable to better understand how the advantages having been announced are associated with the technical novelties of the invention.

### LIST OF NUMERICAL REFERENCES AND/OR OF CORRESPONDING PREFERENTIAL COMPONENTS ILLUSTRATED IN THE ENCLOSED DRAWINGS AND/OR BEING POSSIBLE FOR THE PRESENT SYSTEM

1. concentrator system (and/or associated method)
3. fluid (ex. liquid, such as a “solution”, or “maple sap”, for instance)
3a. original fluid to be processed (ex. “raw” maple sap to be processed)
3b. undesirable fluid to be removed (ex. “water” content to be removed)
3c. resulting fluid having been processed (ex. “concentrated” maple sap)
5. fluid circuit (of concentrator system)
7. osmotic membrane (ex. reverse osmosis membrane)
9. reservoir (for original fluid to be processed)
11. driving device (and/or driving force, equipment, etc.)
11a. proactive driving device (ex. “feeding pump”, etc.)
11b. passive driving device (ex. differential height and/or effect of gravity, etc.)
13. filtering device (ex. filter, screen, etc.)
15. orifice(s) (of filter)
17. cartridge filter
19. pressuring device (ex. “high-pressure pump”, etc.)
21. substantially rigid container (ex. stainless steel container, etc.)
23. inlet (of substantially rigid container, for receiving fluid to be processed)
25. outlet (of substantially rigid container, for releasing “undesirable” fluid)
27. outlet (of substantially rigid container, for releasing “concentrated” fluid)
29. recirculating device
111. longitudinal axis (ex. of coiled osmotic membrane and/or container)

The present concentrator system (1) (and the different inventive aspects thereof) can take-on different forms and/or expressions, including one and/or several of the following components and features (and/or different combination(s) and/or permutation(s) thereof), given as optional and/or preferential embodiment(s) only:
i.) A concentrator system for processing maple sap intended for a production of maple syrup, the concentrator system comprising:
a fluid circuit for receiving maple sap to be processed from a given source of maple sap; and
at least one osmotic membrane operatively disposed about the fluid circuit and in fluid connection with the maple sap to be processed, for passing said maple sap to be processed through the at least one osmotic membrane, at differential pressure of at least 600 PSI, in order to withdraw water content from the maple sap being processed and thus obtain a resulting concentrated maple sap in one single step.
ii.) A concentrator system according to any one of the preceding combination(s), wherein the given source of maple sap includes at least one reservoir of maple sap to be processed, said at least one reservoir being operatively connectable to the fluid circuit of the concentrator system.
iii.) A concentrator system according to any one of the preceding combination(s), wherein the concentrator system includes at least one proactive driving device (ex. a feeding pump, etc.) operatively connectable to the fluid circuit for driving maple sap to be processed through said fluid circuit and towards the at least one osmotic membrane.
iv.) A concentrator system according to any one of the preceding combination(s), wherein the concentrator system includes at least one passive driving device (ex. elevational height(s) and/or disposition(s) of interacting component(s) of the fluid circuit and/or the effect of gravity on the liquid passing therethrough, etc.) operatively connectable to the fluid circuit for driving maple sap to be processed through said fluid circuit and towards the at least one osmotic membrane.
v.) A concentrator system according to any one of the preceding combination(s), wherein the concentrator system includes at least one filter operatively disposed about the fluid circuit for removing unwanted debris from maple sap to be processed prior to passing through the at least one osmotic membrane.
vi.) A concentrator system according to any one of the preceding combination(s), wherein the at least one filter is positioned, shaped and sized, and further provided with corresponding offices, so as retain unwanted debris having a given span of at least 5 microns.
vii.) A concentrator system according to any one of the preceding combination(s), wherein the at least one filter includes a cartridge filter.
viii.) A concentrator system according to any one of the preceding combination(s), wherein the at least one filter includes at least one pair of corresponding filters being disposed in series about the fluid circuit, upstream of the at least one osmotic membrane.
ix.) A concentrator system according to any one of the preceding combination(s), wherein the concentrator system includes at least one pressurizing device (ex. a high-pressure pump, etc.) operatively connectable to the fluid circuit for providing the at least one osmotic membrane with a differential pressure of at least 600 PSI.
x.) A concentrator system according to any one of the preceding combination(s), wherein the at least one osmotic membrane is insertable into a substantially rigid container (ex. made of stainless steel, non-corrosive metallic material, plastic material, composite material, and/or other type of material, etc.) being operatively disposed about the fluid circuit.
xi.) A concentrator system according to any one of the preceding combination(s), wherein the at least one osmotic membrane is coiled about itself along a given longitudinal axis, and wherein said at least one coiled osmotic membrane is nestable inside the substantially rigid container (for instance, inside a “cylindrical” rigid container, as exemplified in the accompanying drawings, although other types of geometrical configuration(s) and/or arrangement(s) are contemplated by the present concentrator system).
xii.) A concentrator system according to any one of the preceding combination(s), wherein the substantially rigid container includes at least one inlet for receiving the maple sap to be processed, and at least one pair of corresponding outlets, one outlet of the container being used for releasing water having been withdrawn from the maple sap having been processed with the at least one osmotic membrane, and another outlet of the container being used for releasing the resulting concentrated maple sap.
xiii.) A concentrator system according to any one of the preceding combination(s), wherein the concentrator system comprises a recirculating device (ex. a recirculating pump, inner and/or outer fluid passageways, etc.) being operatively disposed about the substantially rigid container, and being further positioned, shaped and sized for recirculating maple sap to be processed with said substantially rigid container.
xiv.) A concentrator system according to any one of the preceding combination(s), wherein the at least one osmotic membrane includes at least one pair of corresponding osmotic membranes.
xv.) A concentrator system according to any one of the preceding combination(s), wherein each osmotic membrane is insertable into a corresponding and separate rigid container, each container being operatively disposed about the fluid circuit.
xvi.) A concentrator system according to any one of the preceding combination(s), wherein the at least one pair of corresponding osmotic membranes and associated separate containers are disposed in series about the fluid circuit.
xvii.) A method of processing maple sap intended for a production of maple syrup, the improvement wherein the method comprises the step of passing the maple sap to be processed through at least one osmotic membrane subject to a differential pressure of at least 600 PSI, in order to obtain a resulting concentrated maple sap having more than 25° Brix, in one single step.
xviii.) A method according to any one of the preceding combination(s), wherein the method comprises the step of passing the maple sap to be processed through at least one filter, prior to a passage through the at least one osmotic membrane, in order to removed unwanted debris from the maple sap to be processed.
xix.) A method according to any one of the preceding combination(s), wherein the method comprises the step of placing the at least one osmotic membrane into a corresponding substantially rigid and pressurized container.
xx.) A method according to any one of the preceding combination(s), wherein the method comprises the step of recirculating maple sap to be processed within the container and about the at least one osmotic membrane.
xxi.) A method according to any one of the preceding combination(s), wherein the method comprises the step of separating water having been withdrawn from the maple sap having been processed from the resulting concentrated maple sap having been obtained.

Indeed, and generally, as better illustrated in the enclosed drawings, the present concentrator system is used for the production of maple syrup (to be noted: the expression(s) “maple sap” and/ “maple syrup” in the context of the present patent specification must be interpreted in a “large” sense in that the present system can be used with various other types of saps and/or for the production of various other types of syrups, as evident for a person skilled in the art).

Several changes, additions, modifications and/or alterations can be made to the present concentrator system, without changing nor altering the nature and the scope of the present invention.

For example, the present concentrator system may be “manually-operated” and/or “automated”, and in which case, may be provided with a corresponding “controller”, and/or “management” system (ex. device, programming, control and/or display panel, etc.), and thus, it is important to mention that any other type of “controller” (and/or associated components/aspects) could be used for the present concentrator system, to the extent that this “controller” can be a mechanical system, an electromechanical system, an electronic system, a processor and/or a computer that can be programmed with parameters having to be maintained during the operation and/or associate step(s) of the concentrator system, as can be easily understood by a person skilled in the art.

As may now be better appreciated, the present system enables to operate a concentrator system and/or various aspects thereof (ex. reducing biomass being required to do, etc.), for example, and to be able to do so in a quicker, simpler, more precise, more efficient, more economical, more reliable, more adjustable, more versatile, more adaptable, more durable, more environmentally conscientious, more desirable, and/or improved manner, than what is possible with the actual way of doing things.

Finally, and according to the present invention, the controller (and/or resulting system) and its corresponding parts are preferably made of substantially rigid materials, such as metallic materials (stainless steel, etc.), hardened polymers, composite materials, and/or any other appropriate material, whereas other components of the system (ex. gasket(s), O-ring(s), etc.) according to the present invention, in order to obtain the advantages discussed above, could be made of any other appropriate material, such as polymeric materials (ex. plastic, rubber, etc.), and/or any other suitable material, depending on the particular applications for which the system is intended for and the different parameters in cause, as apparent to a person skilled in the art.

Although the present invention has been previously explained by way of preferred embodiments, it is to be understood that any modification to these preferred embodiments is not considered changing nor altering the nature and the scope of the present invention. Indeed, the scope of the enclosed claim(s) should not be limited by the preferred embodiments set forth in the examples, but should be given the broadest interpretation consistent with the description as a whole.

1. A concentrator system for processing maple sap for production of maple syrup, the concentrator system comprising:
a fluid circuit for receiving maple sap to be processed from a given source of maple sap; and
at least one osmotic membrane operatively disposed about the fluid circuit and in fluid connection with the maple sap to be processed, for passing said maple sap to be processed through the at least one osmotic membrane, at differential pressure of at least 600 PSI, to withdraw water content from the maple sap being processed and obtain a resulting concentrated maple sap in one single step.

2. A concentrator system according to claim 1, wherein the given source of maple sap includes at least one reservoir of maple sap to be processed, said at least one reservoir being operatively connectable to the fluid circuit of the concentrator system.

3. A concentrator system according to claim 1, wherein the concentrator system includes at least one driving device operatively connectable to the fluid circuit for driving maple sap to be processed through said fluid circuit and towards the at least one osmotic membrane, and wherein the at least one driving device includes at least one feeding pump.

4. A concentrator system according to claim 1, wherein the concentrator system includes at least one filter operatively disposed about the fluid circuit for removing unwanted debris from maple sap to be processed prior to passing through the at least one osmotic membrane.

5. A concentrator system according to claim 4, wherein the at least one filter is positioned, shaped and sized, and further provided with corresponding offices, to retain unwanted debris having a given span of at least 5 microns.

6. A concentrator system according to claim 4, wherein the at least one filter includes a cartridge filter.

7. A concentrator system according to claim 4, wherein the at least one filter includes at least one pair of corresponding filters being disposed in series about the fluid circuit, upstream of the at least one osmotic membrane.

8. A concentrator system according to claim 1, wherein the concentrator system includes at least one pressurizing device operatively connectable to the fluid circuit for providing the at least one osmotic membrane with a differential pressure of at least 600 PSI.

9. A concentrator system according to claim 1, wherein the at least one osmotic membrane is insertable into a substantially rigid container being operatively disposed about the fluid circuit.

10. A concentrator system according to claim 9, wherein the at least one osmotic membrane is coiled about itself along a given longitudinal axis, and wherein said at least one coiled osmotic membrane is nestable inside the substantially rigid container.

11. A concentrator system according to claim 9, wherein the substantially rigid container includes at least one inlet for receiving the maple sap to be processed, and at least one pair of corresponding outlets, one of the outlets of the container being configured for releasing water having been withdrawn from the maple sap having been processed with the at least one osmotic membrane, and another one of the outlets of the container being configured for releasing resulting concentrated maple sap.

12. A concentrator system according to claim 9, wherein the concentrator system comprises a recirculating device being operatively disposed about the substantially rigid container, and being further positioned, shaped, and sized for recirculating maple sap to be processed with said substantially rigid container.

13. A concentrator system according to claim 1, wherein the at least one osmotic membrane includes at least one pair of corresponding osmotic membranes.

14. A concentrator system according to claim 13, wherein each osmotic membrane is insertable into a corresponding and separate rigid container, each container being operatively disposed about the fluid circuit.

15. A concentrator system according to claim 14, wherein the at least one pair of corresponding osmotic membranes and associated separate containers are disposed in series about the fluid circuit.

16. A method of processing maple sap for production of maple syrup, wherein the method comprises the step of passing the maple sap to be processed through at least one osmotic membrane subject to a differential pressure of at least 600 PSI, to obtain a resulting concentrated maple sap having more than 25° Brix, in one single step.

17. A method according claim 16, wherein the method comprises the step of passing the maple sap to be processed through at least one filter, prior to a passage through the at least one osmotic membrane, to remove unwanted debris from the maple sap to be processed.

18. A method according to claim 16, wherein the method comprises the step of placing the at least one osmotic membrane into a corresponding substantially rigid and pressurized container.

19. A method according to claim 16, wherein the method comprises the step of recirculating maple sap to be processed within the container and about the at least one osmotic membrane.

20. A method according to claim 16, wherein the method comprises the step of separating water having been withdrawn from the maple sap having been processed from the resulting concentrated maple sap having been obtained.
